(19) United States
(12) Patent Application Publication
(10) Pub. No.: US 2022/0195715 A1
(43) Pub. Date: Jun. 23, 2022

(54) JOIST RECEIVING METAL FITTING, FLOOR STRUCTURE, AND METHOD FOR BUILDING FLOOR STRUCTURE

(71) Applicant: SEKISUI HOUSE, LTD., Osaka-shi Osaka (JP)

(72) Inventor: Ryosuke SATO, Osaka-shi Osaka (JP)

(21) Appl. No.: 17/278,721

(22) PCT Filed: Jun. 23, 2020
(86) PCT No.: PCT/JP2020/024614

§ 371 Date: Mar. 23, 2021

(51) Int. Cl. E04B 1/26; E04B 5/02; E04F 15/02

(52) U.S. Cl. CPC E04B 1/26; E04F 15/02; E04B 5/02

(57) ABSTRACT

A joist receiving metal fitting, a floor structure, and a method for building the floor structure are provided that are configured to prevent contact between the joist and the joist receiving metal fitting even when the joist is fixed to a floor base panel in advance and building is performed. Each of the joist receiving metal fittings includes fixing portions configured to be fixed to a side surface of each of the floor beams and a receiving portion projecting horizontally from the floor beam to receive an end portion of each of the joists. The receiving portion has a bottom plate on which a bottom surface of the joist is to be placed, the pair of side plates rising from both side edges of the bottom plate, and bulging portions that are formed at respective upper ends of the side plates and bulge in directions where they approach each other.

### TECHNICAL FIELD

The present invention relates to a joist receiving metal fitting configured to receive a joist installed between floor beams, a floor structure using the joist receiving metal fitting, and a method for building a floor structure.

### BACKGROUND ART

Conventionally, a floor structure has been known in which joist receiving metal fittings are fixed to side surfaces of floor beams with nails, the joists are supported by the joist receiving metal fittings so that the joists are built to be flush with floor beams, and a floor base panel is provided on the floor beams and joists. In such a building method, an adhesive for cushioning is injected between the each of the joist receiving metal fittings and each of the joists to prevent floor noise due to rubbing between the joist receiving metal fitting and the joist.

In order to shorten the floor assembly work process as described above and improve workability, a technique has also been proposed in which the joists are fixed to a lower surface of the floor base panel in advance. The joists are dropped into the joist receiving metal fittings fixed to the side surfaces of the floor beams so that the process is shortened by simultaneously building the joists and the floor base plate.

### CITATION LIST

### Patent Literature

Patent Literature 1: JP 2007-132159 A

### SUMMARY OF THE INVENTION

### Technical Problem

However, in the above-described process, since the joists are dropped into the joist receiving metal fittings fixed to the side surfaces of the floor beams in a state where the floor base panel is fixed on the joists, the work is performed in a state where positions of the joist and the joist receiving metal fitting cannot be directly confirmed due to the floor base panel being an obstacle. Thus, if there is a slight deviation in the positions of the joists and the joist receiving metal fittings, there is a risk that the joist receiving metal fittings and the joists abut on each other without interposition of the adhesive for cushioning, and floor noise occurs.

Therefore, an object of the present invention is to provide a joist receiving metal fitting, a floor structure, and a method for building the floor structure capable of preventing contact between the joist and the joist receiving metal fitting even when the joist is fixed to a floor base panel in advance and building is performed.

### Solution to Problem

A joist receiving metal fitting of the present invention is a joist receiving metal fitting configured to receive an end portion of a joist installed between floor beams, the joist receiving metal fitting including: a fixing portion configured to be fixed to each of the floor beams; and a receiving portion that is formed so as to project horizontally from the floor beam and receives the end portion of the joist, in which the receiving portion has a bottom plate on which a bottom surface of the joist is to be placed, a pair of side plates that rises from both side edges of the bottom plate and faces each other at a distance wider than a width of the joist, and a pair of bulging portions that is formed at respective upper ends of the side plates and that bulges in directions where the bulging portions approach each other.

Further, in the joist receiving metal fitting of the present invention, a cushioning material is provided on the bottom plate.

Further, in the joist receiving metal fitting of the present invention, each of the tip portions is formed at a position higher than an upper surface of the end portion of the joist, and a distance between the pair of the bulging portions is shorter than the width of the joist.

A floor structure of the present invention includes: floor beams disposed in parallel at intervals; and the above-described joist receiving metal fitting fixed to a side surface of each of the floor beams; and a floor base panel having a joist fixed to a lower surface, wherein the joist has a cutout portion in which an upper surface of an end portion is cut out downward.

A method for building a floor structure of the present invention includes the steps of: fixing the joist receiving metal fittings to floor beams disposed in parallel at intervals; disposing a floor base panel having a joist fixed to a lower surface is disposed so that both ends of the joist are placed on the respective joist receiving metal fittings; and fixing the floor base panel to the floor beams.

### Advantageous Effects of Invention

According to the joist receiving metal fitting of the present invention, since when the end portion of the joist is inserted into the receiving portion of the joist receiving metal fitting from above, the position of the joist is guided by the bulging portions formed at the upper ends of the side plates of the joist receiving metal fitting, the end portion of the joist can be set up in a center of the joist receiving metal fitting, and since the side plates of the joist receiving metal fitting are formed at the distance wider than the width of the joist, a gap between each of the side plates and the joist can be provided. Therefore, it is possible to prevent the joist and the side plate from rubbing against each other and causing floor noise.

Further, according to the joist receiving metal fitting of the present invention, since the cushioning material is provided on the bottom plate, the cushioning material is disposed between the lower surface of the joist end portion and the bottom plate of the joist receiving metal fitting, and since as described before, the gap is provided between each of the side surfaces of the joist and each of the side plates of the joist receiving metal fitting, the joist receiving metal fitting and the joist do not abut on each other, and floor noise can be prevented. Since the gap is formed between the side surface of the joist and the side plate of the joist receiving metal fitting, the cushioning material needs to be provided only on the bottom plate of the joist receiving metal fitting, so that the cushioning material can be easily disposed. Note that here, the cushioning material may be, for example, a wet material such as a resin adhesive, or a dry material such as a flexible solid resin.

Further, according to the joist receiving metal fitting of the present invention, since the distance between the pair of bulging portions is shorter than the width of the joist, when the joist is inserted into the joist receiving metal fitting from above, the end portion of the joist abuts on the bulging portions, the joist receiving metal fitting is elastically deformed so that the distance between the bulging portions is increased, and the joist can be surely guided to a center in a width direction of the joist receiving metal fitting. Since each of the bulging portions is formed at a position higher than the upper surface of the end portion of the joist, when the lower surface of the end portion of the joist abuts on the cushioning material provided on the bottom surface of the joist receiving metal fitting, the upper surface of the end portion of the joist is disposed at a position lower than the bulging portions, which allows the gap to be provided between the end portion of the joist and the bulging portions, so that floor noise can be prevented.

According to the floor structure of the present invention, since the joist has, at the upper surface of the end portion, the cutout portion that is cut out downward, the upper surface of the end portion of the joist can be disposed at the position lower than the bulging portions of the joist receiving metal fitting without decreasing a height of the whole joist, so that it is possible to prevent the end portion of the joist from coming into contact with the joist receiving metal fitting while preventing a strength of the floor structure from decreasing.

In the method for building the floor structure of the present invention, since the joist receiving metal fittings are fixed to the floor beams disposed in parallel at intervals, the floor base panel having the joist fixed to the lower surface is disposed so that both the ends of the joist are placed on the respective joist receiving metal fittings, and the floor base panel is fixed to the floor beams, even if a worker cannot directly view the end portion of the joist and the joist receiving metal fittings because of the floor base panel, the bulging portions of each of the joist receiving metal fittings allow the position of each of the end portions of the joist to be surely guided to the center in the width direction of each of the joist receiving metal fittings, and the joist and the joist receiving metal fitting can be prevented from coming into contact with each other, so that floor noise can be prevented.

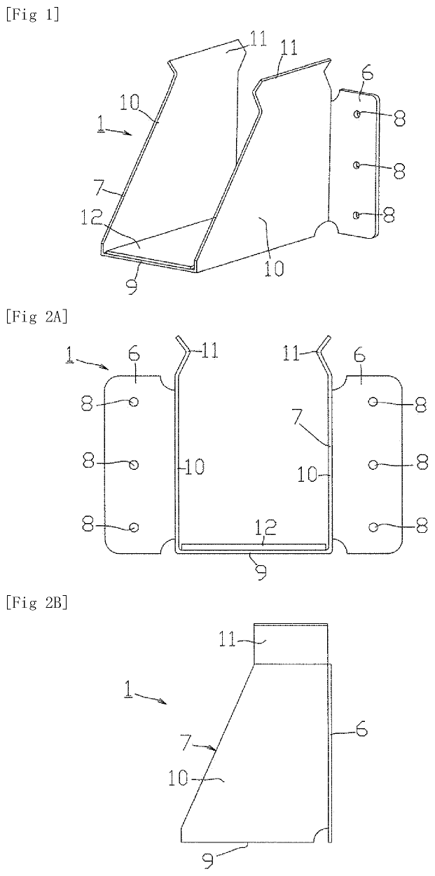

FIG. 1 Perspective view to show the overall structure of embodiment of a joist receiving metal fitting

FIG. 2A Front view to show the overall structure of embodiment of a joist receiving metal fitting

FIG. 2B Side view to show the overall structure of embodiment of a joist receiving metal fitting

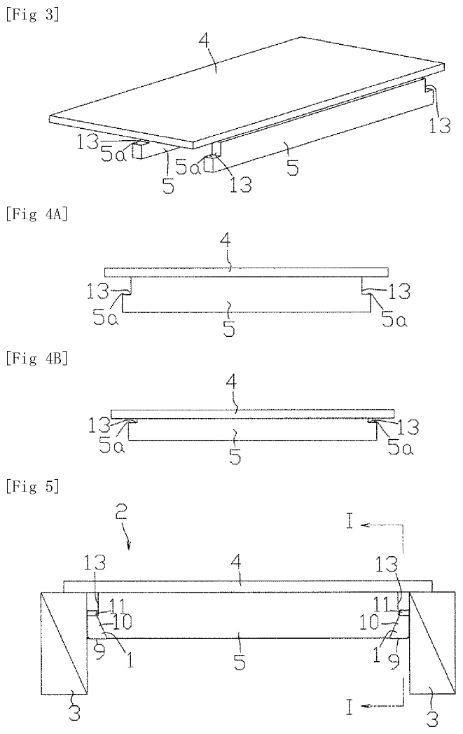

FIG. 3 Perspective view to show the overall structure of floor base panel and joist

FIG. 4A Side view to show the overall structure of floor base panel and joist

FIG. 4B Side view to show the example of using a different sized joist from drawing 4A

FIG. 5 Cross-section view to show the overall floor structure

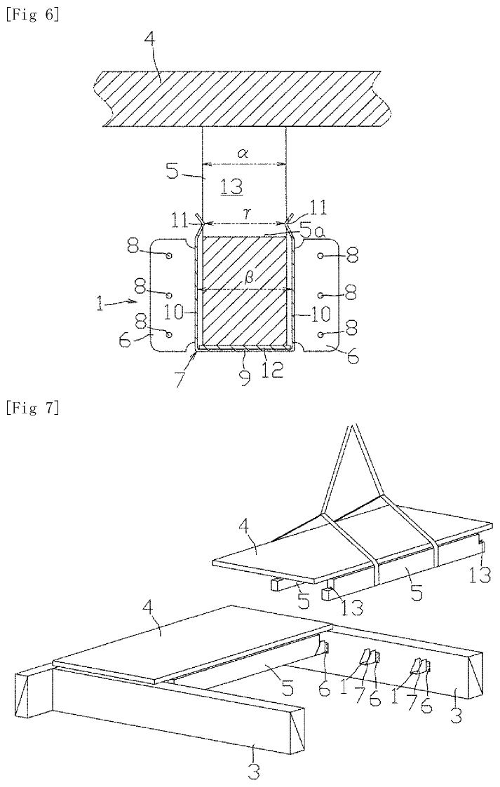

FIG. 6 Cross-section view to show the size of the joist edge and joist receiving metal fitting

FIG. 7 Perspective view to show the state of floor base panel, with which the joist fixed at lower surface, before fixing to floor beams and joist receiving metal fitting

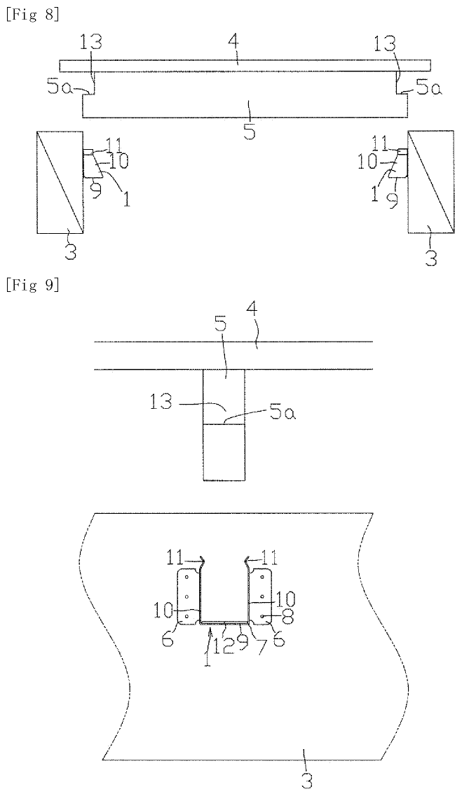

FIG. 8 Side view to show the state of floor base panel, with which the joist fixed at lower surface, before fixing to floor beams and joist receiving metal fitting

FIG. 9 View to show the state of joist edge before inserted in joist receiving metal fitting

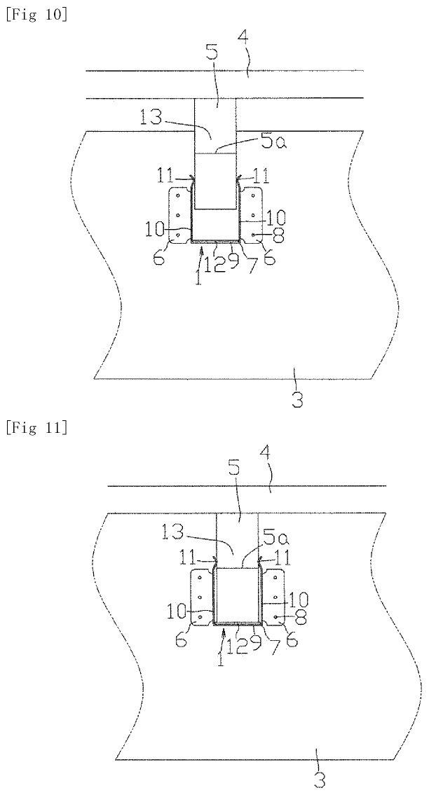

FIG. 10 View to show the state of joist edge being inserted in joist receiving metal fitting

FIG. 11 View to show the state of joist edge after inserted in joist receiving metal fitting

### DESCRIPTION OF EMBODIMENT

Hereinafter, a best embodiment of a joist receiving metal fitting 1, a floor structure 2, and a method for building the floor structure according to the present invention will be described with reference to the drawings. The floor structure 2 in the present embodiment is, for example, a floor structure 2 in which the joist receiving metal fittings 1 are provided on floor beams 3 of a house, and joists 5 fixed to a lower surface of a floor base panel 4 are inserted into the joist receiving metal fittings 1 from above to be received by the joist receiving metal fittings 1. The floor structure 2 may be a floor structure configured to support a floor on the first-floor level or a floor structure configured to support a floor on the second- or higher floor level.

Each of the joist receiving metal fittings 1 includes fixing portions 6 configured to be fixed to a side surface of each of the floor beams 3 and a receiving portion 7 projecting horizontally from the floor beam 3 to receive an end portion of each of the joists 5. As shown in FIGS. 1 and 2A, the fixing portions 6 are plates that extend to both sides from positions where side plates 10 of the receiving portion 7 abut on the floor beam 3. In each of the fixing portions 6, screw holes 8 for fixing the joist receiving metal fitting 1 to the floor beam 3 are formed at three locations arranged in line in a vertical direction.

As shown in FIGS. 1, 2A, and 2B, the receiving portion 7 has a bottom plate 9 on which a bottom surface of the joist 5 is to be placed, the pair of side plates 10 rising from both side edges of the bottom plate 9, and bulging portions 11 that are formed at respective upper ends of the side plates 10 and bulge in directions where they approach each other. The receiving portion 7 is formed by bending a steel plate. The bottom plate 9 is formed is formed to be a horizontal flat plate when the joist receiving metal fitting 1 is fixed to the floor beam 3, and has a width that enables the bottom plate 9 to receive the end portion of the joist 5. The side plates 10 are disposed so that a distance β between the pair of side plates 10 is longer than a width a of the joist 5 in order that each of the side plates 10 is disposed, with a gap, parallel to each of the side surfaces of the joist 5.

As shown in FIGS. 1 and 2A, the bulging portions 11 are formed so that upper ends of the side plates 10 are bent in the directions where they approach each other and upper portions thereof are further bent in directions where they separate from each other. A length of each of the side plates 10 in a height direction is larger than a height of the end portion of the joist 5, and each of the bulging portions 11 formed at the upper end of the side plate 10 is disposed at a position higher than an upper surface 5a of the end portion of the joist 5. Further, the bulging portions 11 are formed so that a distance γ between positions closest to each other is shorter than the width a of the joist 5.

Further, a cushioning material 12 is fixed on the bottom plate 9 of the receiving portion 7. The cushioning material 12 may be, for example, an adhesive having elasticity after being cured, such as a modified silicon elastic adhesive, or an elastic body pre-molded into a flat plate shape. The cushioning material 12 is provided only on the bottom plate 9, and is not provided on the side plates 10 and the bulging portions 11. This is because the gap is surely formed between each of the side plates 10 and each of the joist 5, so that there is no possibility that the side plate 10 and the joist 5 rub against each other and floor noise occurs, and it is not necessary to provide the cushioning material 12. By not providing the cushioning material 12 on the side plates 10 and the bulging portions 11 in this way, it is possible to reduce the building work.

The joist receiving metal fitting 1 may be fixed to the floor beam 3 in advance with a screw (not shown) at a factory and carried to a construction site, or may be fixed to the floor beam 3 with a screw at the construction site. A position where the joist receiving metal fitting 1 is set up in the floor beam 3 is a position where the joist 5 is installed on the floor beam 3, and the joist receiving metal fitting 1 is set up so that an upper surface of an intermediate portion of the joist 5 inserted into the joist receiving metal fitting 1 and an upper surface of the floor beam 3 are flush with each other.

As shown in FIGS. 3, 4A, and 4B, the joist 5 is a square timber, and cutout portions 13 obtained by cutting out upper surfaces of end portions downward are formed at both ends. Each of the cutout portions 13 is created by cutting the timber from the upper surface downward at the end portion of the joist 5, and cutting horizontally from an edge surface of the joist 5 so that a corner of the upper end is cut out at a right angle. That is, the joist 5 is formed so that a lower surface is flush and the cutout portions 13 are formed at both the ends of the upper surfaces, which makes each of the upper surfaces 5a at the end portions lower than the upper surface of the other portion.

As shown in FIG. 5, the width a of the joist 5 is shorter than the distance β between the side plates 10 of the joist receiving metal fitting 1 and is longer than the closest distance γ between the bulging portions 11 of the joist receiving metal fitting 1. Further, the upper surface 5a of the end portion of the joist 5 is lower than the bulging portions 11 of the joist receiving metal fitting 1, and has a shape in which when the end portion of the joist 5 is inserted into the joist receiving metal fitting 1, the end portion of the joist 5 does not come into contact with the bulging portions 11. A length of each of the cutout portions 13 in a longitudinal direction of the joist 5 is larger than a length of each of the bulging portions 11 in the longitudinal direction of the joist 5, so that the bulging portions 11 do not come into contact with the end portion of the joist 5. Note that, while the upper surface of the intermediate portion of the joist 5 is formed higher than the end portion to ensure a strength of the joist 5, the height of the intermediate portion of the joist 5 can be appropriately selected depending on a strength required for the floor structure 2 and a beam depth of the floor beam 3, as shown in FIGS. 4A and 4B.

The floor base panel 4 is a plate material that is carried, from the factory to the construction site, with the joists 5 fixed to the lower surface in advance. As shown in FIG. 3, the two joists 5 are fixed to the floor base panel 4 along a length direction of the floor base panel 4. One of the two joists 5 is fixed to a center in a width direction of the floor base panel 4, and the other joist 5 of the two joists 5 is fixed to one edge of the floor base panel 4. The other joist 5 is formed so that a half of the other joist 5 in the width direction is fixed to the one edge of the floor base panel 4, the other half protrudes from the edge of the floor base panel 4, and another edge of an adjacent floor base panel 4 is placed on the portion of the other joist 5 that protrudes from the floor base panel 4.

Further, the floor beam 3 is a horizontal square timber that receives a floor load and, although not shown, an end portion is fixed to a column or another beam by a beam receiving metal fitting. As shown in FIG. 5, a plurality of floor beams 3 are disposed in parallel at intervals, and the floor beams 3, the joist receiving metal fittings 1 fixed to the side surfaces of the floor beams 3, and the floor base panel 4 having the joists 5 fixed to the lower surface configure the floor structure 2.

In a method of the floor structure having the above configuration, the floor beams 3 are carried from the factory to the construction site with the joist receiving metal fittings 1 fixed to the floor beams 3, and the plurality of floor beams 3 are installed in parallel by joining the end portions of the floor beams 3 to another beam, a column or the like so that the joist receiving metal fittings 1 are aligned to the positions where the joists 5 are installed. Note that in the present embodiment, the joist receiving metal fittings 1 are fixed to the floor beam 3 at the factory, but the present invention is not limited to this, and may be fixed to the floor beam 3 at the construction site, and for example, after the plurality of floor beams 3 are disposed in parallel at intervals, the joist receiving metal fittings 1 may be fixed.

The floor base panel 4 is carried from the factory to the construction site with the joists 5 fixed to the lower surface of the floor base panel 4. A process of fixing the joists 5 to the lower surface of the floor base panel 4 is not limited to the process performed at the factory, but, for example, after the floor base panel 4 is carried to the construction site, the joists 5 may be fixed to the lower surface of the floor base panel 4.

As shown in FIGS. 7 to 9, the floor base panel 4 having the joists 5 fixed is lifted, for example, by a crane, and is disposed so that each of the joists 5 fixed to the lower surface of the floor base panel 4 is located above the joist receiving metal fittings 1 fixed to the floor beams 3. Then, the floor base panel 4 is gradually lowered, and as shown in FIG. 10, the end portion of the joist 5 is inserted into the joist receiving metal fitting 1. At this time, the distance γ at the closest position between the pair of bulging portions 11 formed in the receiving portion 7 of the joist receiving metal fitting 1 is shorter than the width a of the joist 5. Thus, when the floor base panel 4 is lowered, the lower end edge of the joist 5 abuts on the bulging portions 11. When the floor base panel 4 is further lowered, the pair of bulging portions 11 are elastically deformed in the directions where they spread with respect to each other, and the joist 5 is lowered so that the bulging portions 11 go along the side surfaces of the joist 5. At this time, since the pair of bulging portions 11 abuts on both the side surfaces of the joist 5, the joist 5 is guided to the center of the joist receiving metal fitting 1.

When the floor base panel 4 is still further lowered, the lower surface of the joist 5 abuts on the cushioning material 12 provided on the bottom plate 9 of the receiving portion 7 of the joist receiving metal fitting 1, and the joist 5 is received by the joist receiving metal fitting 1. At the end portion of the joist 5, the upper surface 5a is formed lower than the bulging portions 11 due to the cutout portion 13, and the distance β between the pair of side plates 10 of the receiving portion 7 of the joist receiving metal fitting 1 is larger than the width a of the joist 5. Thus, the side surfaces of the joist 5 do not abut on the joist receiving metal fitting 1, and the joist 5 is not in contact with the joist receiving metal fitting 1 since the lower surface of the joist 5 is placed on the joist receiving metal fitting 1 with the cushioning material 12 interposed. Therefore, it is possible to prevent the occurrence of floor noise caused by the rubbing between the joist 5 and the joist receiving metal fitting 1.

In this way, the bulging portions 11 are provided in the joist receiving metal fitting 1 to guide the position of the joist 5, and the cutout portion 13 is provided at the end portion of the joist 5 to prevent the end portion of the joist 5 and the joist receiving metal fitting 1 from coming into contact with each other. Thus, in the building method of the floor structure in which the joist 5 is fixed to the lower surface of the floor base panel 4 in advance, even if the end portion of the joist 5 and the joist receiving metal fitting 1 cannot be visually recognized because of the floor base panel 4, the joist 5 can be disposed in the center of the joist receiving metal fitting 1, and the end portion of the joist 5 and the joist receiving metal fitting 1 can be surely prevented from coming into contact with each other.

Note that it is needless to say that the embodiment of the present invention is not limited to the above-described embodiment and can be appropriately altered without departing from the scope of the idea of the present invention.

### INDUSTRIAL APPLICABILITY

The joist receiving metal fitting 1, the floor structure 2, and the method for building the floor structure according to the present invention can be preferably used, for example, when the floor structure of a house is built.

### DESCRIPTION OF REFERENCE SIGNS

1 Joist receiving metal fitting
2 Floor structure
3 Floor beams
4 Floor base panel
5 Joist
6 Fixing portion
7 Receiving portion
8 Bottom plate
10 Side plate
11 Bulging portion
12 Cushioning material
13 Cutout portions

1. A joist receiving metal fitting configured to receive an end portion of a joist installed between floor beams, the joist receiving metal fitting comprising:
a fixing portion configured to be fixed to each of the floor beams; and
a receiving portion that is formed so as to project horizontally from the floor beam and receives the end portion of the joist,
wherein the receiving portion has a bottom plate on which a bottom surface of the joist is to be placed, a pair of side plates that rises from both side edges of the bottom plate and faces each other at a distance wider than a width of the joist, and a pair of bulging portions that is formed at respective upper ends of the side plates and that bulges in directions where the bulging portions approach each other.

2. The joist receiving metal fitting according to claim 1, wherein a cushioning material is provided on the bottom plate.

3. The joist receiving metal fitting according to claim 2, wherein each of the bulging portions is formed at a position higher than an upper surface of the end portion of the joist, and a distance between the pair of the bulging portions is shorter than the width of the joist.

4. A floor structure comprising:
floor beams disposed in parallel at intervals; and
the joist receiving metal fitting according to claim 3 fixed to a side surface of each of the floor beams; and a floor base panel having a joist fixed to a lower surface,
wherein the joist has a cutout portion in which an upper surface of an end portion is cut out downward.

5. A method for building a floor structure, comprising the steps of:
fixing the joist receiving metal fittings according to claim 3 to floor beams disposed in parallel at intervals;
disposing a floor base panel having a joist fixed to a lower surface is disposed so that both ends of the joist are placed on the respective joist receiving metal fittings; and
fixing the floor base panel to the floor beams.
